(19) United States
(12) Patent Application Publication
(10) Pub. No.: US 2011/0181564 A1
(43) Pub. Date: Jul. 28, 2011

(54) METHOD OF DRIVING INFORMATION DISPLAY PANEL

(75) Inventors: Akihiko Yokoo, Tokyo (JP); Norio Nihei, Tokyo (JP)

(73) Assignee: BRIDGESTONE CORPORATION, Chuo-ku, Tokyo (JP)

(21) Appl. No.: 13/122,234

(22) PCT Filed: Oct. 2, 2009
(86) PCT No.: PCT/JP2009/067256

§ 371 Date: Apr. 7, 2011

(30) Foreign Application Priority Data
Oct. 2, 2008 (JP) 2008-257447

(51) Int. Cl. G09G 5/00

(52) U.S. Cl. 345/204

(57) ABSTRACT

A method of driving an information display panel in which a display medium 3 comprised of a particle group containing chargeable particles is sealed between two opposing substrates 1, 2, at least one of which substrates is transparent, and, the display medium is moved between the substrates in accordance with an electric filed applied based on electrodes 5, 6 provided to the respective substrates, thereby to display information, in which, at a time of erasing a display, an entire screen AL for displaying the information is divided into a plurality of subareas DA-1, DA-2, and, one-time erasing is sequentially performed for each of the plurality of subareas. It is possible to reduce a peak value of electric power consumption, while performing erasing in a short period of time as compared with a case where line erasing is performed. More preferably, it is possible to maintain display quality by performing erasing in finely subareas to which the electric field is applied at intervals of every predetermined number of column electrodes.

### TECHNICAL FIELD

The present invention relates to an information display panel in which a display medium comprised of a particle group containing chargeable particles is sealed between two panel substrates, at least one of which panel substrates is transparent, and, the display medium is moved, thereby to display information such as an image, and more specifically, relates to a method of efficiently driving the information display panel.

### RELATED ART

As an information display device, a liquid crystal display device (LCD) is widely used. However, in general, it has been known that the liquid display device consumes a large amount of electric power, and has various drawbacks such as a narrow viewing angle. In view of the facts above, as a substitute for the liquid crystal display, there is proposed an information display device in which plural cells sectioned by partition walls are formed between two substrates (for example, glass substrates), at least one of which substrates is transparent, a display medium comprised of a particle group containing chargeable particles is sealed in the cells, and, electrical field is applied to the display medium, thereby to display information such as an image.

The information display panel as described above is provided, for example, with a pair of electrodes for generating an electric field in a space between substrates in accordance with information such as an image, and displays the information such as an image by moving the particle group in accordance with the generated electric field. The displayed information can be visually recognized through a transparent panel substrate disposed on the display surface side. Further, at the time of erasing the displayed information, a predetermined electric current is applied to the electrodes, and an electric field is generated over the entire screen in the same direction to move the same type of a particle group to the same substrate side.

For example, Patent Literature 1 discloses an information display panel employing the technique above, and describes in paragraph 0020 that pairs of electrodes are formed as line electrodes so as to face each other and perpendicularly intersect each other; information such as an image is displayed by means of the line electrodes; and, the displayed information may be erased for each line electrode, that is, line erasing, or all the information displayed on the entire screen may be erased at one time (simultaneously). However, in a case of line erasing, the displayed information is sequentially erased line by line, and thus a longer period of time is required. Accordingly, from the viewpoint of reducing the erasing time, it is desirable to employ the one-time erasing.
Patent Literature 1: Japanese Patent Application Laid-open No. 2005-331904

### DISCLOSURE OF THE INVENTION

### Problems to be Solved by the Invention

However, in the information display panel described above, for example, about 100 to 200 row electrodes (scanning electrodes) are arranged as line electrodes on the one side of a substrate, while about 300 to 400 column electrodes (data electrodes) are arranged as line electrodes on the other side of the substrate. Then, a voltage is applied between the large number of line electrodes to generate a predetermined electric field, whereby the information can be written, or erased.

In a case of the one-time erasing as described above, it is necessary to apply a predetermined voltage or more to all the electrodes to generate an electrical field for erasing all the displayed information. Therefore, the information display panel employing the one-time erasing involves the large amount of electric power at its peak during the one-time erasing, and hence, requires a large-sized electric power supply (electric power supply module) capable of supplying said large amount of electric power. Accordingly, the information display panel becomes larger size, resulting in increase in the cost.

Further, as a matter of course, it is desired that the erasing process is reliably performed so that no unwanted images and the like are left. An inappropriate erasing operation adversely affects the quality of display thereafter.

In view of the facts described above, an object of the present invention is to solve the problem related to erasing of the displayed information such as an image described above and the problem related to one-time erasing, and to propose a method of displaying information and erasing the displayed information by efficiently driving an information display panel, and further propose a method of driving the information display panel while paying attention to display quality at the time of the displaying and erasing.

### Means for Solving the Problem

The above-described object can be achieved by a method of driving an information display panel in which a display medium comprised of a particle group containing chargeable particles is sealed between two opposing substrates, at least one of which substrates is transparent, and, the display medium is moved between the substrates in accordance with an electric filed applied based on electrodes provided to the respective substrates, thereby to display information, in which, at a time of erasing a display, an entire screen for displaying the information is divided into a plurality of subareas, and, one-time erasing is sequentially performed for each of the plurality of subareas.

Further, each of the subareas obtained by dividing the entire screen may contain the same number of the electrodes.

Yet further, it is further desirable that the two substrates are configured to contain plural row electrodes as the electrodes arranged on a first substrate and plural column electrodes as the electrodes arranged on a second substrate; the erasing is performed in a first subarea that is finely divided by applying the electric field at intervals of every predetermined number of the column electrodes; and, thereafter, the erasing is performed in a second subarea that is finely divided by applying the electric field to the remaining column electrodes. Yet further, the entire screen may be divided equally into two to obtain the first subarea and the second subarea.

### Effect of the Invention

According to a method of driving an information display panel of the present invention, it is possible to reduce the amount of the electric power consumption at its peak as compared with a conventional case where the one-time erasing is performed for the entire screen, and to erase the entire screen within a short period of time as compared with the case where the displayed information is sequentially erased line by line, by employing a method in which the entire screen (entire area of the information display) is divided into plural subareas, and one-time erasing is sequentially performed for each of said subareas. This makes it possible for the information display panel implementing the driving method according to the present invention to erase the information in a relatively short period of time while miniaturizing the information display panel and reducing the cost thereof.

As described above, it is possible to reduce the peak of the electric power generated at the time of erasing the display even in a case of a passive drive employing line electrodes and designed such that the entire screen is divided into plural areas, and the one-time erasing is performed for each of the subareas. However, there may be a case where line-like afterimage (boundary line) occurs at a boundary portion between the subareas when the respective subareas are sequentially erased. If such a boundary line is left, there is a concern that the display quality of the information display panel deteriorates. In view of the facts above, the present inventors reached an idea of further finely dividing the subareas as described above as a favorable improved method of driving a dot matrix type information display panel for erasing the displayed information while dealing with the facts described above and reducing the peak of the electric power. This makes it possible to equally disperse the large number of boundary lines to make the boundary lines less noticeable.

### BRIEF DESCRIPTION OF THE DRAWINGS

FIG. 1A and FIG. 1B are diagrams for explaining a principle configuration of an information display panel to which the present invention is directed.

FIG. 2A and FIG. 2B are diagrams for explaining other principle configuration of the information display panel to which the present invention is directed.

FIG. 3A and FIG. 3B are diagrams for explaining other principle configuration of the information display panel to which the present invention is directed.

FIG. 4 is a diagram for explaining other principle of the information display panel to which the present invention is directed.

FIG. 5 is an expanded plan view illustrating line electrodes disposed on substrates.

FIG. 6 is a diagram illustrating a state where the entire screen is divided equally into two subareas, and the subareas are sequentially erased.

FIG. 7 is a diagram illustrating a state where the finely divided subareas are erased.

FIG. 8 is a diagram illustrating an example of shapes of partition walls in the information display panel to which the present invention is directed.

### BEST MODE FOR CARRYING OUT THE INVENTION

Hereinbelow, a method of driving an information display panel according to an embodiment of the present invention will be described in detail with reference to the drawings. For the purpose of facilitating understanding of the present invention, a description will be made of a schematic configuration of an information display panel that employs a display medium comprised of a particle group containing chargeable particles, moves the display medium, thereby displaying information such as a character and an image.

In the information display panel as one example to which the present invention is applied, a display medium comprised of a particle group containing chargeable particles is sealed in a space between two opposing substrates, and an electric field is applied to the sealed display medium. The display medium is drawn by force resulting from the electric field or Coulomb force along the direction of the applied electric field, and moves due to change of directions of the applied electric field, whereby information such as an image is displayed. Therefore, the display information panel needs to be designed so as to be able to uniformly move the display medium, and maintain stability at the time when the displayed information is repeatedly rewritten, or when the displayed information continues to be displayed. In addition to the attraction force caused by the Coulomb force between the respective particles, the force acting on the particles constituting the display medium may include electric image force with the electrode or substrate, intermolecular force, liquid cross-linking force, gravity and the like.

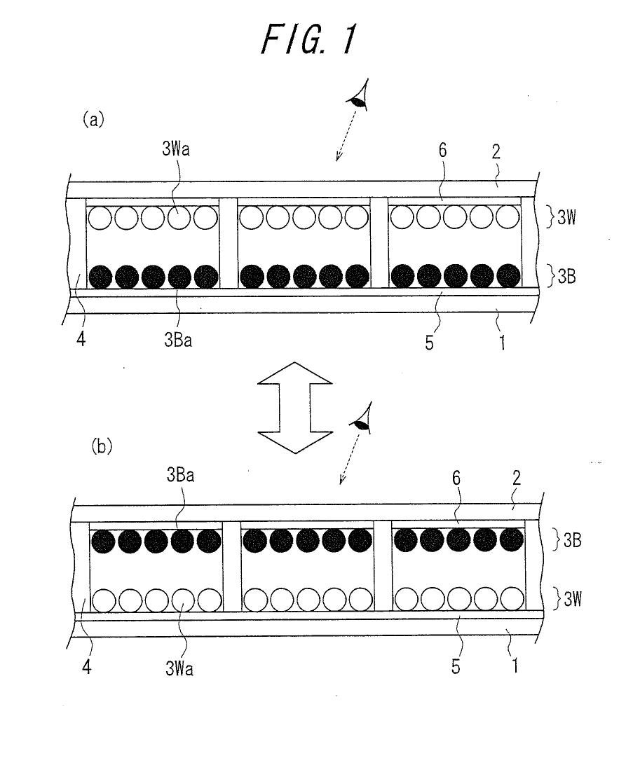

An example of the information display panel to which the present invention is directed to will be described with reference to FIGS. 1(a) and 1(b) through FIGS. 4(a) and 4(b).

In the example illustrated in FIGS. 1(a) and 1(b), at least two types of display media (in this example, a white color display medium 3W comprised of a particle group containing negatively electrified white color particles 3Wa and a black color display medium 3B comprised of a particle group containing positively electrified black color particles 3Ba are illustrated) comprised of particle groups containing particles having at least an optical reflectivity and an electrification property, which are different between the display medium types, are moved perpendicular to substrates 1, 2 in each cell formed by a partition wall 4 in accordance with an electric field generated by applying a voltage across a pair of electrodes formed by an electrode 5 (line electrode) provided to the substrate 1 and an electrode 6 (line electrode) provided to the substrate 2, the respective electrodes of which face each other and perpendicularly intersect each other. Then, a white display can be performed by making the white color display medium 3W visually recognized by an observer as illustrated in FIG. 1(a), or a black display can be performed by making the black color display medium 3B visually recognized by the observer as illustrated in FIG. 1(b), whereby dot matrix display of white and black can be performed.

Note that, in FIGS. 1(a) and 1(b), a partition wall existing at the frontward side is omitted. It may be possible to dispose the respective electrodes 5, 6 on the outside of the substrates 1, 2, or on the inside of the substrates 1, 2, or is disposed so as to be embedded in the substrate.

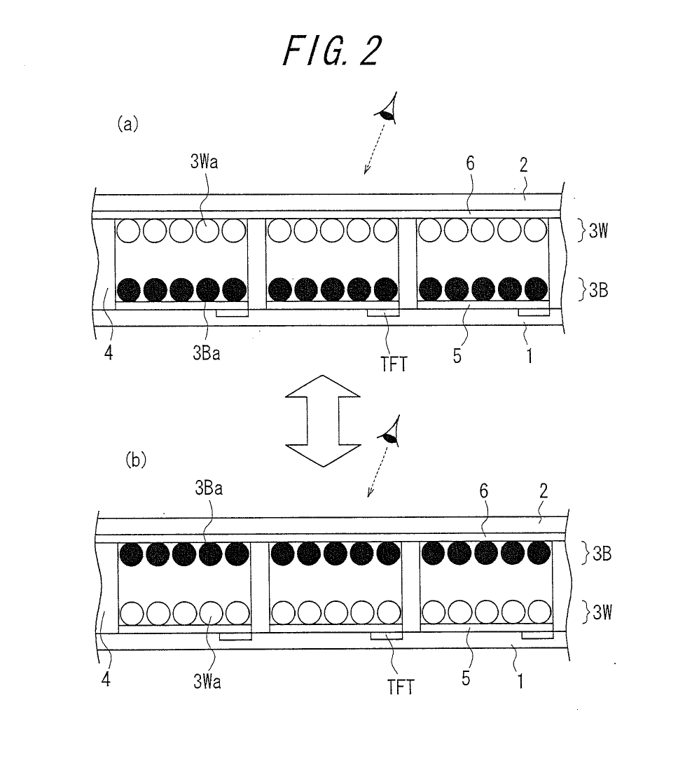

In an example illustrated in FIGS. 2(a) and 2(b), at least two types of display media (in this example, a white color display medium 3W comprised of a particle group containing negatively electrified white color particles 3Wa and a black color display medium 3B comprised of a particle group containing positively electrified black color particles 3Ba are illustrated) comprised of particle groups containing particles having at least an optical reflectivity and an electrification property, which are different between the display medium types, are moved perpendicular to substrates 1, 2 in each cell formed by a partition wall 4 in accordance with an electric field generated by applying a voltage across a pair of pixel electrodes formed by an electrode 5 (pixel electrode having TFT) provided to the substrate 1 and an electrode 6 (common electrode) provided to the substrate 2. Then, a white display can be performed by making the white color display medium 3W visually recognized by an observer as illustrated in FIG. 2(a), or a black display can be performed by making the black color display medium 3B visually recognized by the observer as illustrated in FIG. 2(b), whereby dot matrix display of white and black can be performed.

Note that, in FIGS. 2(a) and 2(b), a partition wall existing at the frontward side is omitted. It may be possible to dispose the respective electrodes 5, 6 on the outside of the substrates 1, 2, or on the inside of the substrates 1, 2, or is disposed so as to be embedded in the substrate.

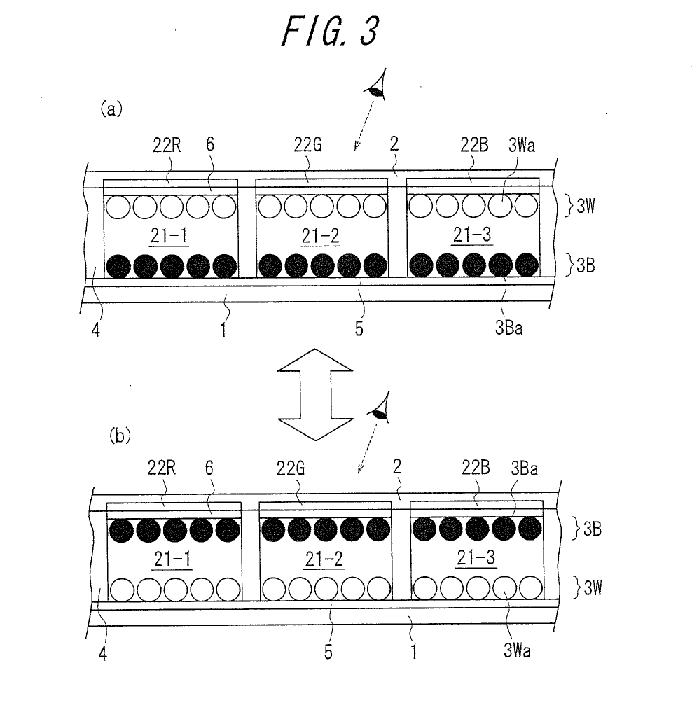

FIGS. 3(a) and 3(b) illustrate an example of color display in which a unit of display (1 dot) is formed by three cells. In the example illustrated in FIGS. 3(a) and 3(b), all cells 21-1 through 21-3 are filled with a negatively electrified white color display medium 3W and a positively electrified black color display medium 3B as the display medium. A red color filter 22R is provided on an observer side of the first cell 21-1; a green color filter 22G is provided on the observer side of the second cell 21-2; and, a blue color filter 22B is provided on the observer side of the third cell 21-3. The unit of display (1 dot) is formed by three cells of the first cell 21-1, the second cell 21-2 and the third cell 21-3 described above.

In this example, at the time of performing the color display, the white color display medium is moved to the observer side in any one of the first cell 21-1, the second cell 21-2 and the third cell 21-3, while the black color display medium is moved to the observer side in the other cells, whereby display of red color, green color or blue color can be performed. Then, as illustrated in FIG. 3(a), the white dot display is performed for the observer by moving the white color display media 3W in all of the first cell 21-1 through the third cell 21-3 to the observer side. Further, as illustrated in FIG. 3(b), the black dot display is performed for the observer by moving the black color display media 3B in all of the first cell 21-1 through the third cell 21-3 to the observer side. Note that, in the configuration exemplarily illustrated in FIGS. 3(a) and 3(b), a partition wall existing at the frontward side is omitted. Multiple color display can be performed by appropriately moving the display media in the respective cells.

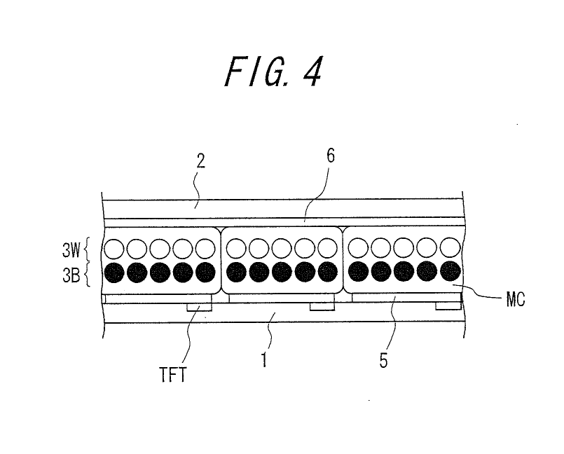

In an example illustrated in FIG. 4, the white and black dot displays are performed such that a white particle group and a black particle group each having electrified property and sealed in a microcapsule together with an insulating liquid are disposed as the display media between panel substrates 1 and 2; and, the electric field is applied from a pair of electrodes formed by the common electrode 6 provided to the substrate on the observer side, and the pixel electrode 5 having TFT and provided to the substrate on the back surface side, which is not required to be transparent. This example employs a type in which a microcapsule MC is disposed between the substrates, and, the display media 3W and 3B in the microcapsule MC are driven (electrophoresis) by using the electric field generated between the pair of pixel electrodes formed such that the pixel electrode 5 having TFT and formed on the substrate 1 (on the back surface side) and the transparent common electrode (transparent conductive film) 5 formed on the substrate 2 (on the observer side) face each other. The gap between the substrates is maintained at a predetermined space by using a spacer.

It should be noted that it is possible to employ as the substrates 1, 2 described above a glass substrate, a resin sheet substrate, a resin film substrate or other substrate. The substrate 2 disposed on the display surface side (observer side) as illustrated in the drawing is a transparent substrate. On each of the two substrates, an electrode for applying a predetermined voltage having polarity (positive/negative) is provided, and the two substrates are formed so as to face each other, thereby forming a pair of electrodes. On the surface of each of the two front and back substrates 1 and 2 constituting the display panel described above, there is formed the pixel electrode or line electrode so as to form a matrix-formed pair of electrodes. When a voltage is applied to the electrodes, the electric field is applied to the display media (particle groups), and the display media are moved, whereby it is possible to achieve the above-described structure that can perform a desired display.

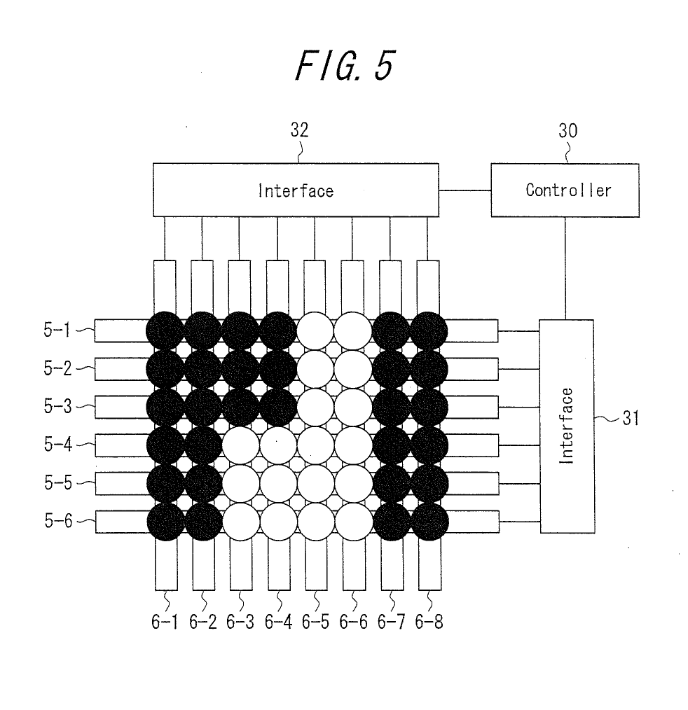

FIG. 1 through FIG. 4 are side views of configurations of information display panels each enlarged so as to be able to view a schematic configuration of cells of the information display panel. FIG. 5 is an enlarged plan view illustrating a matrix arrangement of pixels (dots) formed by line electrodes disposed on the substrates 1, 2. For the purpose of simplification, FIG. 5 schematically illustrates 8×6 pixels formed by row electrodes (scanning electrodes) 5-1 to 5-6 disposed on the lower substrate 1 and column electrodes (data electrodes) 6-1 to 6-8 disposed on the upper substrate 2. A pixel at a position at which the row electrode and the column electrode intersect each other (rounded portion) corresponds to each of the cells described above, and two types of display media of white and black are sealed in the cells. The display panel having the configuration illustrated in FIG. 1 is illustrated.

At the time of displaying the information, a voltage is applied to the row electrodes 6-1 to 6-8 and the column electrodes 5-1 to 5-6 in accordance with information to be displayed, and the display medium existing in the corresponding pixel (dot) is moved, thereby displaying the information with a white/black dot.

It should be noted that, as illustrated in FIG. 5, the row electrodes 5-1 to 5-6 and the column electrodes 6-1 to 6-8 are connected with a controller 30 configured mainly by a CPU through interfaces 31, 32, respectively. The controller 30 controls a voltage applied to the row electrodes 5-1 to 5-6 and the column electrodes 6-1 to 6-8 according to a predetermined display program. At the time of displaying information such as an image, which is requested to be displayed, or erasing the displayed information such as an image, the controller 30 produces a signal corresponding to the displaying or erasing, and selects from the row electrodes 5-1 to 5-6 and the column electrodes 6-1 to 6-8 depending on applications to apply a necessary electric field to a specific pixel (dot).

At the time of erasing the displayed information such as an image, the time required for erasing the displayed information can be most reduced by applying the voltage between all of the row electrodes and all of the column electrodes to erase the entire screen at one time (at the same time). However, in this case, an electric power supply module for the information display panel becomes undesirably larger as described above.

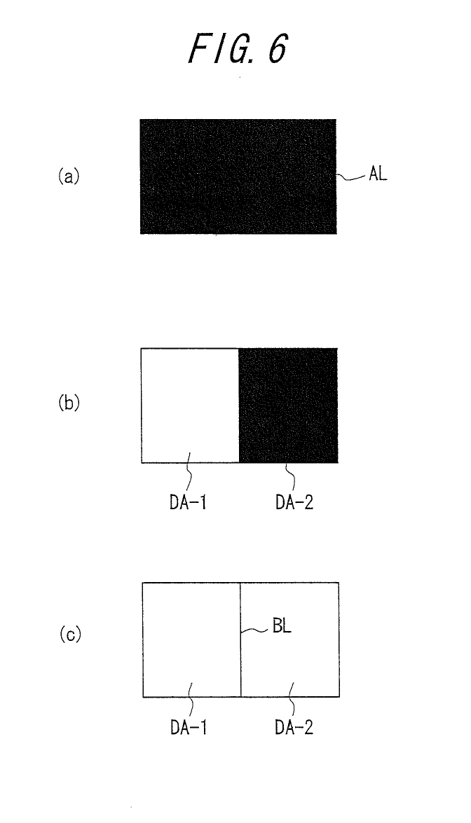

Therefore, as illustrated in FIG. 6, the entire screen AL for displaying the information can be divided into plural areas DA (hereinafter, referred to as subarea DA). By erasing the displayed information in such a manner that the one-time erasing is sequentially performed for each of the subareas DA, the peak electric power required for each one-time erasing can be suppressed, and at the same time, the time required for erasing can be reduced as compared with the case where the displayed information is sequentially erased line by line. This makes it possible to erase the information in a relatively short period of time while miniaturizing the required electric power supply module.

It should be noted that FIG. 6 exemplarily illustrates a case where a display is erased in such a manner that an all-black display as illustrated in FIG. 6(a) is changed finally into an all-white display. In FIG. 6, the entire screen AL is divided into two: a first subarea DA-1 and a second subarea DA-2. The display in the first subarea DA-1 is first erased as illustrated in FIG. 6(b), and then, the display in the second subarea DA-2 is erased as illustrated in FIG. 6(c).

In particular, FIG. 6 exemplarily illustrates a case where, at the time of setting the subareas DA by dividing the entire screen AL, the entire screen AL is divided equally into two such that the respective subareas DA contain the same number of line electrodes. By setting the subareas by dividing the entire screen such that the respective subareas contain the same number of line electrodes, it is possible to supply the same peak electric power in a similar manner, and reliably implement efficient erasing. When both of the subareas DA are set to contain the same number of the line electrodes as described above, it is possible to simplify the structure corresponding to this, and the configuration of the control thereof.

It should be noted that, although FIG. 6 exemplarily illustrates a case of two divisions in which the entire screen AL is divided into two areas, it may be possible to divide the entire screen AL into three or more. In this case, as the number of the subareas DA increases by increasing the number of division, the electric power peak required for erasing can be further reduced, which makes it possible to reduce the size of the required electric power supply module. However, in this case, the time required for erasing increases, which should be taken into consideration comprehensively at the time of determination.

The present inventors recognized that, when the entire screen AL is divided as described above and the one-time erasing is performed in the order of the first subarea DA-1 and then the second subarea DA-2, some line-like afterimage (hereinafter, referred to as boundary line BL) appears at a boundary portion between the first subarea DA-1 and the second subarea DA-2, as illustrated in FIG. 6(c). If the boundary line BL as described above is left, there is a concern that the display quality as an information display panel deteriorates.

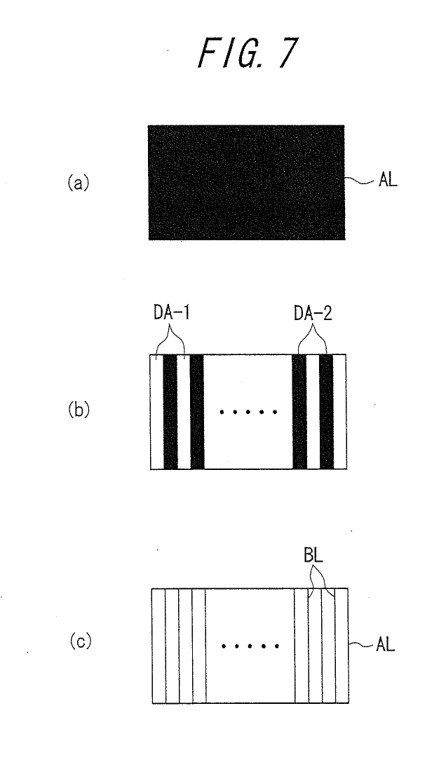

In view of the facts described above, the present inventors further improved the basic idea of the aforementioned present invention, and devised a more favorably method of driving an information display panel capable of dealing with the boundary line BL while reducing the peak electric power required for erasing as described above. This point will be described with reference to FIG. 7.

Similar to FIG. 6, FIG. 7 exemplarily illustrates a process in which plural subareas DA are set in an all-black display that is displayed in the entire screen AL as illustrated in FIG. 7(a), the one-time erasing is sequentially performed to the all-black display for each of the subareas DA, and the display is finally erased to be a white display. Although both FIG. 6(b) and FIG. 7(b) illustrate manners in which the one-time erasing is performed to the first subareas DA-1, the manners themselves are different from each other.

In a case of FIG. 7(b), the first subarea DA-1 set by finely dividing the entire area AL. More specifically, FIG. 7(b) illustrates a case where, by applying an electric field at intervals of every predetermined number of column electrodes (for example, two lines to five lines), the finely divided first subareas DA-1 . . . are set, and a predetermined electric field is generated in a similar manner to the aforementioned case to perform the one-time erasing.

FIG. 7(c) illustrates a case where an electric field is then applied to the remaining column electrodes, and the same erasing process is performed to the finely divided second subareas DA-2. Note that, as a matter of course, by setting the finely divided first subareas DA-1 . . . as described above, the finely divided second subareas DA-2 . . . are also formed between the finely divided first subareas.

In a state illustrated in FIG. 7(c), a large number of the boundary lines BL are generated between the finely divided first subareas DA-1 and the finely divided second subareas DA-2. For example, when about 300 line electrodes are arranged as column electrodes, about 150 boundary lines BL are formed if a screen is finely divided for every two line electrodes, and the first subarea DA-1 and the second subarea DA-2 are alternatively set.

FIG. 7(c) is a diagram schematically illustrated such that the plural boundary lines BL are noticeable. However, in a state illustrated in FIG. 7(c), the large number of boundary lines BL are arranged in the entire screen AL so as to be uniformly spaced, and hence, it is possible to suppress the unnatural feeling that those who view the display panel feel. More specifically, it is possible to make the boundary lines BL less noticeable by uniformly dispersing the large number of boundary lines BL as compared with the case where only one boundary line BL exists at the center of the large display surface as illustrated in FIG. 6(c), thereby suppressing the unnatural feeling that the viewer who views said boundary lines BL feels.

FIG. 7 exemplarily illustrates a preferred embodiment in which the entire screen AL is divided equally into two and erasing is performed, one of which comprises the finely divided first subareas DA-1 and the other of which comprises the finely divided second subareas DA-2. In this configuration, the one-time erasing is performed in the first and the second subareas DA-1, DA-2 while applying the suppressed peak electric power in a similar manner; the increase in the time required for erasing can be suppressed by setting the number of subareas to two, which is the minimum number; and the deterioration of the display quality due to the boundary line BL is addressed by the finely divided subareas. However, depending on application, it may be possible to divide the entire screen AL into three or more to set a third subarea or more subarea.

Six types (Samples No. 1 to No. 6) of information display panels are prepared, and Table 1 below shows results of contrast measurements of the sample information display panels in terms of a case where the entire screen AL is simultaneously erased at one time (“one time” in Table 1), and a case where two subareas each obtained by finely dividing the entire screen AL as illustrated in FIG. 7 are set and one-time erasing is sequentially performed for each of the subareas (“two times” in Table 1).

The contrast refers to a contrast between white and black on the information display panel, and in this embodiment, the contrast is measured in terms of reflection densitometry of an image using a densitometer RD-19 manufactured by Gretagmacbeth. The contrast in this specification refers to a contrast ratio, and is a value obtained by an expression of a contrast ratio=10(B−W), where B is black reflection densitometry, and W is white reflection densitometry, each of which is measured by the densitometer.

TABLE 1

Contrast

| Sample No. | One time | Two times |
|---|---|---|
| 1 | 6.91 | 6.87 |
| 2 | 6.19 | 5.83 |
| 3 | 4.69 | 4.75 |
| 4 | 4.68 | 4.52 |
| 5 | 6.16 | 5.86 |
| 6 | 4.57 | 4.50 |

As can be understood from Table 1 above, although the contrast slightly reduces, almost no problem arises in the case of the method illustrated in FIG. 7 in which the one-time erasing is performed for each of the finely divided subareas (“two times” in Table 1), as compared with the case where the entire screen is simultaneously erased at one time (“one time” in Table 1). Therefore, it is confirmed that sufficient practicality can be obtained in the case of employing the erasing illustrated in FIG. 7.

Below, further description will be made of component members constituting an information display panel to which the present invention is directed.

As the aforementioned substrates, at least one of the substrates is a transparent substrate through which the color of the display medium can be recognized from the outside of the panel, and is preferably made of a material having high transmissivity for the visible lights and exhibiting favorable heat-resisting property. The back side substrate, which is the other one of the substrates, may be either transparent or not transparent. The substrate material includes: an organic polymer based substrate such as polyethylene terephthalate, polyethylene naphthalate, polyethylene, polycarbonate, polyimide, polyether sulfone and acrylic; a glass sheet; quartz sheet; metal sheet; and the like. Of the materials, a transparent material is used for the display surface side. The thickness of the substrate is preferably in a range of 2 to 2000 μm, and is more preferably in a range of 5 to 1000 μm, The excessively thin substrate makes it difficult to maintain a strength thereof and a uniformity of the space between the substrates, and in a case where the thickness of the substrate exceeds 2000 μm, inconvenience occurs at the time of making the information display panel thinner.

The material for forming the electrodes provided on the substrates includes: metals such as aluminum, silver, nickel, copper and gold; electrically conductive metal oxides such as indium tin oxide (ITO), indium zinc oxide (IZO), aluminum zinc oxide (AZO), indium oxide, conductive tin oxide, antimony tin oxide (ATO) and conductive zinc oxide; electrically conductive polymers such as polyaniline, polypyrrole and polythiophene. Depending on application, the material for forming the electrodes can be selected from the materials described above for use. As a method of forming the electrodes, it is possible to use: a method of subjecting the materials exemplified above to pattern formation to be a thin film shape by using a sputtering method, a vacuum deposition method, a chemical vapor deposition (CVD) method and a coating method; a method of laminating metal foils (for example, rolling copper-foil method); and a method of performing pattern formation by applying a mixture of conductive agent with solvent or synthetic resin binder.

The electrode provided in an information display screen area of the substrate on the viewer side (display surface side) needs to be transparent, while it is not necessary for the electrode provided on the back side substrate to be transparent. In any case, it is possible to preferably use the above-described conductive materials that can be used for pattern formation. Note that a thickness of the electrode is only necessary to be set such that the conductivity can be secured and any trouble in optical transparency is not caused, and is in a range of 0.01 to 10 μm, preferably, in a range of 0.05 to 5 μm. The material and thickness of the electrode provided on the back side substrate is set in a similar manner to the electrode provided on the display side substrate described above, but it is not necessary for the electrode provided on the back side substrate to be transparent.

Depending on application, a shape of a partition wall provided to the substrate is optimally set in accordance with types of display media used for displaying, and shapes and arrangement of the electrodes to be disposed, and is not limited in a word. However, a width of the partition wall is set in a range of 2 to 100 μm, preferably, in a range of 3 to 50 μm. A height of the partition wall may be set within the gap between the substrates such that a portion for securing the gap between the substrates is set at the height same as the gap between the substrates, and a portion for forming a cell other than the portion for securing the gap between the substrates is set at the height same as the gap between the substrate or the height lower than the gap between the substrate. Further, it is considered that the partition wall is formed by a both-rib method of forming a rib on each of the opposing substrates 1, 2 and then connecting them, or by a single-rib method of forming a rib on either side of the substrates. In this invention, it is possible to preferably employ any of the methods described above. The height of the partition wall is set so as to match a distance between the substrates, but may be set partially so as to be lower than the distance between the substrates.

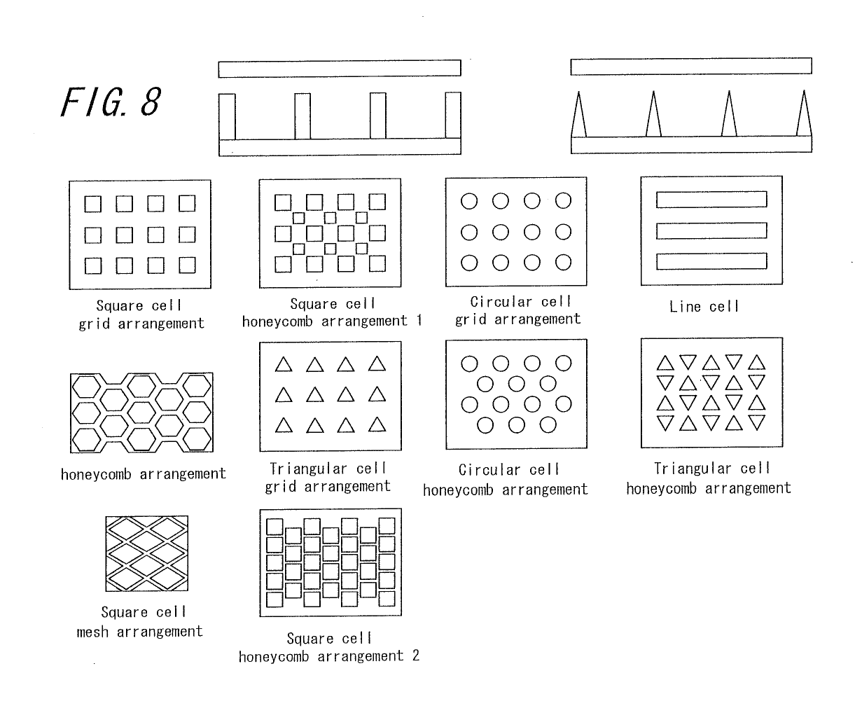

As illustrated in FIG. 8, examples of the cells formed by the partition wall formed by the rib or the ribs described above include a quadrangle shape, triangle shape, line shape, circle shape and hexagon shape as viewed from the direction of the substrate plane, and examples of arrangement thereof include a lattice arrangement, honey-comb arrangement and network arrangement. It is preferable to make a portion corresponding to a sectional area of the partition wall visible from the display surface side (area of frame portion of cell) as small as possible, so that sharpness of the displaying state increases.

Examples of the method of forming the partition wall include a mold transfer method, a screen printing method, a sandblast method, a photolithographic method, and an additive method. Any method can be preferably applied to the information display panel provided to the information display device according to the present invention, but, of the methods described above, the photolithographic method using a resist film or the mold transfer method is preferably used.

There will be described chargeable particles in a case where the display medium according to the present invention is comprised of the particle group containing the chargeable particles. The display medium used is a display medium in which the particle group is formed only by the chargeable particles, or in which the particle group is formed by a mixture with other particles. The chargeable particles are formed principally by resins, which may contain a charging control agent, colorant, inorganic additive and the like depending on applications. Examples of the resins, charging control agent, colorant, and other additives will be described below.

Examples of the resins principally constituting the chargeable particles include a urethane resin, urea resin, acrylic resin, polyester resin, acrylic urethane resin, acrylic urethane silicone resin, acrylic urethane fluororesin, acrylic fluororesin, silicone resin, acrylic silicone resin, epoxy resin, polystyrene resin, styrene-acrylic resin, polyolefin resin, butyral resin, vinylidene chloride resin, melamine resin, phenol resin, fluororesin, polycarbonate resin, polysulfone resin, polyether resin, and polyamide resin, and two or more resins may be mixed. In particular, considering control of adhesion strength with the substrate, it is preferable to use the acrylic urethane resin, acrylic silicone resin, acrylic fluororesin, acrylic urethane silicone resin, acrylic urethane fluororesin, fluororesin, and silicone resin.

There is not any particular limitation for the charging control agent, but examples of negative charging control agents include salicylic acid metal complex, metal-containing azo dye, metal-containing (including metal ion or metal atom) oil-soluble dye, quaternary ammonium salt compound, calixarene compounds, boron containing compound (benzilic acid boron complex), and nitroimidazole derivative. Examples of positive charging control agents include nigrosine dye, triphenylmethane-based compound, quaternary ammonium salt compound, polyamine resin, and imidazole derivative. Additionally, it may be possible to employ, as the charging control agent, ultrafine powder silica; ultrafine powder titanium oxide; metallic oxides such as ultrafine powder alumina; nitrogen containing ring compound such as pyridine and its derivative; and resin containing salt, various kinds of organic pigments, fluorine, chlorine and nitrogen.

As exemplified below, various types and colors of organic and inorganic pigments and dyes may be used as the colorant. Black colorant includes carbon black, copper oxide, manganese dioxide, aniline black, active carbon and the like. Blue colorant includes C.I. pigment blue 15:3, C.I. pigment blue 15, iron blue, cobalt blue, alkali blue lake, victoria blue lake, phthalocyanine blue, metal-free phthalocyanine blue, phthalocyanine blue partial chlorine compound, first sky blue, indanthrene BC and the like. Red colorant includes colcothar, cadmium red, red lead, mercury sulfide, cadmium, permanent red 4R, lithol red, pyrazolone red, watching red, calcium salt, lake red D, brilliant carmine 6B, eosine lake, rhodamine lake B, alizarin lake, brilliant carmine 3B, C.I. pigment red 2 and the like.

Yellow colorant includes chrome yellow, zinc yellow, cadmium yellow, yellow iron oxide, mineral first yellow, nickel titanium yellow, navel yellow, naphthol yellow S, hansa yellow G, hansa yellow 10G, benzidine yellow G, benzidine yellow GR, quinoline yellow lake, permanent yellow NCG, tartrazine lake, C.I. pigment yellow 12 and the like. Green colorant includes chrome green, chromium oxide, pigment green B, C.I. pigment green 7, Malachite green lake, final yellow green G and the like. Orange colorant includes red chrome yellow, molybdenum orange, permanent orange GTR, pyrazolone orange, Balkan orange, indunsren brilliant orange RK, benzidine orange G, Indusren brilliant orange GK, C.I. pigment orange 31 and the like. Purple colorant includes manganese purple, first violet B, methyl violet lake and the like. White colorant includes zinc oxide, titanium oxide, antimony white, zinc sulphide and the like.

Extender includes baryta powder, barium carbonate, clay, silica, white carbon, talc, alumina white and the like. Further, as various dyes such as basic dye, acidic dye, dispersion dye, direct dye and the like, there are nigrosine, methylene blue, rose bengal, quinoline yellow, ultramarine blue, and the like.

Examples of inorganic additives include titanium oxide, zinc oxide, zinc sulphide, antimony oxide, calcium carbonate, white lead, talc, silica, calcium silicate, alumina white, cadmium yellow, cadmium red, cadmium orange, titanium yellow, iron blue, ultramarine blue, cobalt blue, cobalt green, cobalt violet, iron oxide, carbon black, manganese ferrite black, cobalt ferrite black, copper powder, aluminum powder and the like.

The pigments and inorganic additives described above may be used alone or in combination therewith. Particularly, of the colorants described above, carbon black is preferable as the black pigment, and titanium oxide is preferable as the white pigment. Chargeable particles having a desired color can be manufactured by mixing the colorants described above.

Further, it is preferable that the chargeable particles have an average particle diameter d(0.5) in a range of 1 to 20 μm, and the respective particles have a uniform size. In a case where the average particle diameter d(0.5) exceeds this range, the image sharpness on the display deteriorates, and, on the other hand, in a case where the average particle diameter is smaller than this range, a cohesive force between the particles becomes undesirably large, which adversely affects the movement of the particles as the display medium.

Further, in the present invention, it is desirable that, regarding the particle diameter distribution of the chargeable particles, a particle diameter distribution Span, which is defined by the following expression, is less than 5, preferably less than 3.

Span=(d(0.9)−d(0.1))/d(0.5)

(where, d(0.5) indicates a value of the particle diameter expressed by μm in which 50% of the particles have a diameter larger than this value and 50% of the particles have a diameter smaller than this value, d(0.1) indicates a value of the particle diameter expressed by μm in which a percentage of the particles having a diameter smaller than or equal to this value is 10%, and d(0.9) indicates a value of the particle diameter expressed by μm in which a percentage of the particles having a diameter smaller than or equal to this value is 90%.)

By setting the Span to less than or equal to 5, the sizes of the particles are made uniform and the particles can move as the uniform display medium.

Yet further, it is important that, for the particle groups used, a ratio of average particle diameter d(0.5) of the particle group having the smallest average particle diameter with respect to average particle diameter d(0.5) of the particle group having the largest average particle diameter is set to 10 or lower. Even if the particle diameter distribution Span is set to be smaller, the display media having different electrification properties with each other are moved in the opposite directions to each other, and hence, it is preferable that the sizes of the particles constituting the respective display media are formed so as to be equal to each other in order to make the respective display media easily moved in the opposite directions to each other, which is realized by the above-described range.

It should be noted that the particle diameter distribution and the particle diameter of the particle described above can be obtained with a laser diffraction/scattering method and the like. By emitting a laser light to the particles to be measured, a light intensity distribution pattern occurs spatially due to a diffraction/scattering light. This light intensity pattern is in the relationship with the particle diameter, and hence, the particle diameter and the particle diameter distribution can be obtained.

In the present invention, the particle diameter and the particle diameter distribution are obtained on the basis of the volume-based distribution. For example, by using a measurement unit Mastersizer 2000 (Malvern Instruments Ltd.), particles are inserted into a stream of nitrogen to be able to measure the particle diameter and the particle diameter distribution with the attached analysis software (software using a Mie theory and based on the volume-based distribution).

Further, for the information display panel in which display media comprised of particle groups are driven in a space filled with gas, it is important to control the gas located in the space and surrounding the display media between the panel substrates, which contributes to improvement of display stability. More specifically, it is important to set a relative humidity of the gas in the space at 25° C. at 60% RH or lower, preferably, at 50% RH or lower.

The space described above represents a portion existing between the opposing substrate 1 and substrate 2 in FIGS. 1(a) and 1(b) through FIG. 3, excluding the electrodes 5, 6 (in a case where the electrodes are provided on the inner side of the substrates), a portion occupied by the display media, a portion occupied by the partition wall 4 and a sealing portion of the display panels, that is, the space described above indicates a gas portion that is brought in contact with the display media. Any type of gas can be used as the gas in the spaces described above, provided that humidity thereof falls within the humidity range described above. However, it is preferable to use a dried air, dried nitrogen, dried argon, dried helium, dried carbon dioxide, dried methane and the like. This gas needs to be sealed in the information display panels so as to keep the humidity inside thereof, and it is important, for example, to fill the display media, build the information display panels and implement other processes under a predetermined humidity environment, and then, to apply the seal material and sealing method so as to prevent the wet from intruding from the outside.

The space between the substrates of the information display panel to which the present invention is applied is set such that the display medium can move and contrast can be maintained, and is adjusted, generally, in a range of 10 to 500 μm, preferably, in a range of 10 to 200 μm. In a case of an information display panel in which the chargeable particles are moved in gas, the space is set in a range of 10 to 100 μm, preferably, in a range of 10 to 50 μm.

It is preferable that the volume ratio of the display media to the space filled with gas between the opposing substrates is in a range of 5 to 70%, and more preferably, in a range of 5 to 60%. Note that, in a case where the ratio exceeds 70%, movement of the display media is adversely affected, and on the other hand, in a case where the ratio is less than 5%, the contrast is likely to become unclear.

These are detailed descriptions of preferred embodiment, but the present invention is not limited to a specific embodiment. Various modifications and changes can be made within the scope of the spirit of the present invention specified in claims. For example, in the above-described embodiment, a description has been made of a case where the electrodes are line electrodes, as one example, but electrodes are not limited to this. Any type of electrodes can be used as the electrodes disposed on the respective substrates, provided that the electrodes are configured so as to be able to perform one-time erasing for each subarea that is appropriately set.

### INDUSTRIAL APPLICABILITY

An information display panel that employs the driving method according to the present invention is suitable for use in a display unit of various electronic devices including: a display unit of a mobile device such as a notebook computer, an electronic notebook, a mobile-type information device called a PDA (personal digital assistance), a cell phone and a handy terminal; a display device of an electronic paper such as an electronic book, an electronic newspaper and an electronic manual (electronic instruction manual), a message board such as a billboard, a poster, a blackboard and a whiteboard, an electronic desktop calculator, an electrical appliance, an automobile part and the like; a card display unit of a point card, an IC card and the like; a display unit of an electronic advertisement, an information board, an electronic POP (point of presence, point of purchase advertizing), an electronic price tag, an electronic price shelf-tag, an electronic music score and a RFID device; and, a POS terminal, a car-navigation device, clock and the like. Further, the information display panel according to the present invention is suitable for use as a rewritable paper in which a display is rewritten by electrically connecting with external display rewriting means.

It should be noted that various drive types can be used for the driving type of the information display panel, which include: a passive drive type that does not use any switching element in the panel itself, and an active drive type using a TFT as the switching element.

1. A method of driving an information display panel in which a display medium comprised of a particle group containing chargeable particles is sealed between two opposing substrates, at least one of which substrates is transparent, and, the display medium is moved between the substrates in accordance with an electric filed applied based on electrodes provided to the respective substrates, thereby to display information, wherein,
at a time of erasing a display, an entire screen for displaying the information is divided into a plurality of subareas, and,
one-time erasing is sequentially performed for each of the plurality of subareas.

2. The method of driving an information display panel according to claim 1, wherein
each of the subareas obtained by dividing the entire screen contains the same number of the electrodes.

3. The method of driving an information display panel according to claim 1, wherein,
the two substrates are configured to contain a plurality of row electrodes as the electrodes arranged on a first substrate and a plurality of column electrodes as the electrodes arranged on a second substrate,
the erasing is performed in a first subarea that is finely divided by applying the electric field at intervals of every predetermined number of the column electrodes, and,
thereafter, the erasing is performed in a second subarea that is finely divided by applying the electric field to the remaining column electrodes.

4. The method of driving an information display panel according to claim 3, wherein
the entire screen is divided equally into two to obtain the first subarea and the second subarea.
